(19) United States
(12) Patent Application Publication
(10) Pub. No.: US 2006/0274378 A1
(43) Pub. Date: Dec. 7, 2006

(54) Color image enhancement apparatus and method

(75) Inventors: Chia-Lei Yu, Taipei (TW); Hsu-Huang Cheng, Taipei (TW); Tsorng-Yang Mei, Taipei (TW); Ming-Chang Chuang, Taipei (TW)

Correspondence Address: BIRCH STEWART KOLASCH & BIRCH, PO BOX 747, FALLS CHURCH, VA, 22040-0747, US

(73) Assignee: Asmedia Technology Inc.

(21) Appl. No.: 11/446,113

(22) Filed: Jun. 5, 2006

(30) Foreign Application Priority Data
Jun. 7, 2005 (TW) 94118799

(51) Int. Cl. H04N 1/409

(52) U.S. Cl. 358/3.27; 358/518

(57) ABSTRACT

A color image enhancement apparatus has a color attribute interpreter and a color attribute adjuster. The color attribute interpreter generates an adjust signal according to a Hue, a Saturation and a Brightness of a pixel data. Of the adjust signal, each adjustment for each of the Hue, the Saturation and the Brightness is determined by all of the Hue, the Saturation and the Brightness of the pixel data. The color attribute adjuster is connected to the color attribute interpreter. The color attribute adjuster receives the adjust signal and adjusts the transformed color attribute according to the adjust signal.

### RELATED APPLICATIONS

The present application is based on, and claims priority from, Taiwan Application Serial Number 94118799, filed Jun. 7, 2005, the disclosure of which is hereby incorporated by reference herein in its entirety.

### BACKGROUND

1. Field of Invention

The present invention relates to an image apparatus. More particularly, the present invention relates to a color image enhancement apparatus.

2. Description of Related Art

A display is an essential information exchange apparatus for modern people regardless of whether it is a classic cathode ray tube display or a contemporary liquid crystal display. The applications of the cathode ray tube display are very maturity, especially for television and computer applications because the cathode ray tube display is able to provide rich color. In consideration of size and weight, the cathode ray tube display is not well suited to a notebook computer or a personal digital assistant. The liquid crystal display is lightweight and small in size such that the liquid crystal display has replaced the cathode ray tube display in many applications.

A traditional method for recording the color attributes of a digital color image, which are represented by RGB, YUV, YCbCr or YPbPr color coordinates, is not suitable for human vision, and the adjustment of the color attributes of the color image according to the color of each pixel data is difficult. When adjusting Saturation or Brightness, the Saturation or Brightness of all color are increased or deceased. For example, H represents Hue, V represents the value or Brightness, and S represents the Saturation. Traditionally, the adjusted Hue, Brightness and Saturation of all color is:
H′=f(H); S′=f(S); and V′=f(V)

However, the human visual preference of the Brightness and the Saturation for all color is not the same. For example, the user A may prefer high Saturation of red and low Saturation of green, but the user B may prefer low Saturation of red and high Saturation of blue. Thus, if the Saturation or Brightness are increased or deceased and ignoring the human visual preference and the color attributes of each pixel data, the preferred visual effect is unable to be obtained.

### SUMMARY

It is therefore an aspect of the present invention to provide a color image enhancement apparatus, which enhances the color behavior of the color image by adjusting each pixel data of the color image according to a separate Hue, Saturation or Brightness for providing a preferred visual effect.

According to one embodiment of the invention, the color image enhancement apparatus has a color attribute interpreter and a color attribute adjuster. The color attribute interpreter generates an adjust signal according to a Hue, a Saturation and a Brightness of an input pixel data. Of the adjust signal, each adjustment for each of the Hue, the Saturation and the Brightness is determined together by the Hue, the Saturation and the Brightness of the pixel data. The color attribute adjuster is connected to the color attribute interpreter. The color attribute adjuster receives the adjust signal and adjusts the pixel data according to the adjust signal.

According to another embodiment of the invention, the color image enhancement apparatus has a color attribute transformer, a color attribute interpreter and a color attribute adjuster. The color attribute transformer is arranged to transform color attributes of a pixel data. The Hue, the Saturation and the Brightness of the transformed color attributes are represented by HSV color coordinates. The color attribute interpreter is connected to the color attribute transformer and generates an adjust signal according to the transformed color attributes. Of the adjust signal, each adjustment of the adjust signal for each of the Hue, the Saturation or the Brightness is determined by all of the Hue, the Saturation and the Brightness of the pixel data. The color attribute adjuster is connected to the color attribute interpreter. The color attribute adjuster receives the adjust signal and adjusts the transformed color attributes according to the adjust signal.

It is another aspect of the present invention to provide a color image enhancement method, which transforms color attributes of a pixel data for a human visual model represented by a Hue, a Saturation and a Brightness such that the pixel data is adjusted conveniently for enhancing the color behavior.

According to one embodiment of the invention, the color image enhancement method generates an adjust signal according to a Hue, a Saturation and a Brightness of a pixel data. Each adjustment of the adjust signal for each of the Hue, the Saturation or the Brightness is determined by all of the Hue, the Saturation and the Brightness of the pixel data. Then, the pixel data is adjusted according to the adjust signal.

According to another embodiment of the invention, the color image enhancement method transforms color attributes of an original pixel data. The transformed color attributes represent a Hue, a Saturation and a Brightness by HSV color coordinates. Then, an adjust signal is generated according to the transformed color attributes. Each adjustment of the adjust signal for each of the Hue, the Saturation or the Brightness is determined by all of the Hue, the Saturation and the Brightness of the original pixel data. Finally, the original pixel data is adjusted according to the adjust signal to obtain an adjusted pixel data.

It is still another aspect of the present invention to provide a color image enhancement method, which adjusts the color attributes of the color image according to the color of each pixel. Thus, the color behavior of the color image, such as Saturation or Brightness, directed to each pixel data of different Hue is enhanced.

According to another embodiment of the invention, the color image enhancement method employs a color attribute transformer to transform color attributes of an original pixel data. The transformed color attributes represent a Hue, a Saturation and a Brightness by HSV color coordinates. A color attribute interpreter is employed to generate an adjust signal according to the transformed color attributes. Each adjustment of the adjust signal for each of the Hue, the Saturation or the Brightness is determined by all of the Hue, the Saturation and the Brightness of the original pixel data. A color attribute adjuster is employed to receive the adjust signal and adjust the transformed color attributes according to the adjust signal.

In conclusion, the foregoing embodiments of the invention first transform color attributes of the pixel data such that they are adaptable for a human visual model represented by a Hue, a Saturation and a Brightness. Moreover, how the Hue, the Saturation or the Brightness is adjusted is determined by all of the Hue, the Saturation and the Brightness of the pixel data. Thus, the color behavior of the color image, such as Saturation or Brightness, directed to each pixel data of different Hue is enhanced for providing a preferred visual effect to the user.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram according to one preferred embodiment of the invention;

FIG. 2 is a drawing of the color attribute interpreter according to one preferred embodiment of the invention; and

FIG. 3 is a flow chart according to one preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The traditional method is not suited to human vision and is unable to accommodate personal preference of a user because the human visual preference of the Brightness and the Saturation for all color is not the same.

The invention transforms the color attributes of each pixel data to be represented by HSV color coordinates and then adjusts the transformed color attributes of each pixel data separately such that each pixel data is able to suit human vision and personal preference of the user. Anyone of color attribute (such as Hue, Saturation, or Brightness) of each pixel data to be processing is considered of the Hue, the Saturation and, the Brightness. The adjustment relationship of the color attributes may be represented as follows:
H′=f(H,S,V); S′=f(H,S,V); and V′=f(H,S,V)

In other words, the adjusted Hue is a function of the Hue, Saturation and Brightness; the adjusted Saturation is a function of the Hue, Saturation and Brightness; and the adjusted Brightness is a function of the Hue, Saturation and Brightness. Thus, the embodiment of the invention is able to enhance the color behavior of the pixel data for providing a preferred visual effect to the user.

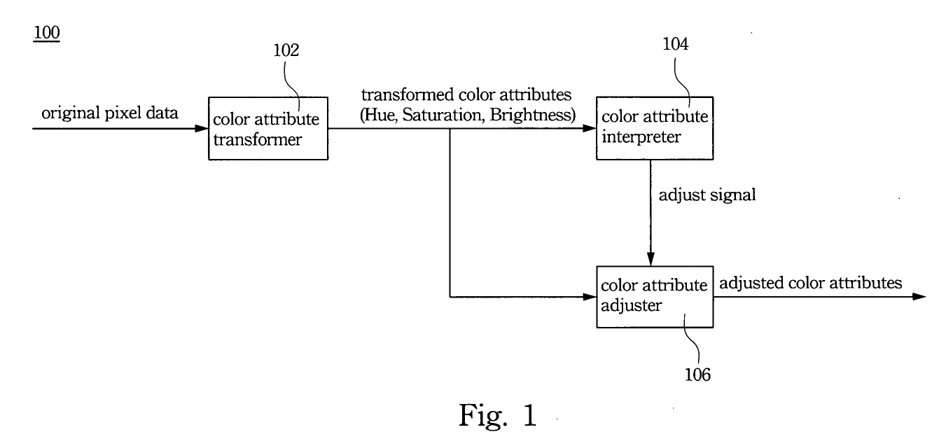

Reference is made to FIG. 1, which is a diagram according to one preferred embodiment of the invention. A color image enhancement apparatus 100 includes a color attribute transformer 102, a color attribute interpreter 104 and a color attribute adjuster 106. The color attribute transformer 102 is arranged to transform color attributes of an original pixel data. The transformed color attributes are represented by HSV color coordinates. The color attribute interpreter 104 is connected to the color attribute transformer 102 and generates an adjust signal according to transformed color attributes. Of the adjust signal, each adjustment of the adjust signal for each of the Hue, the Saturation or the Brightness is determined by all of the Hue, the Saturation and the Brightness of the original pixel data. The color attribute adjuster 106 is connected to the color attribute transformer 102 and the color attribute interpreter 104. The color attribute adjuster 106 receives the adjust signal and adjusts the transformed color attributes according to the adjust signal for obtaining an adjusted pixel data.

The color attribute transformer 102 receives the original pixel data. The color attributes of the original pixel data are represented by RGB, YUV, YCbCr or YPbPr color coordinates. However, these color coordinates are not suitable for human vision. The color attribute transformer 102 transforms the color attributes of the original pixel data such that they are represented by HSV color coordinates suited to human vision.

More specifically, the color attribute transformer 102 transforms the color attributes of the original pixel data from being represented by rectangular coordinates, for example, RGB, YUV, YCbCr or YPbPr color coordinates, to polar coordinates, for example, HSV color coordinates. That is, the transformed color attributes represented by polar coordinates are beneficial to be adjusted by the color attribute adjuster 106 because a Hue, Saturation and Brightness thereof are suitable as a human visual model.

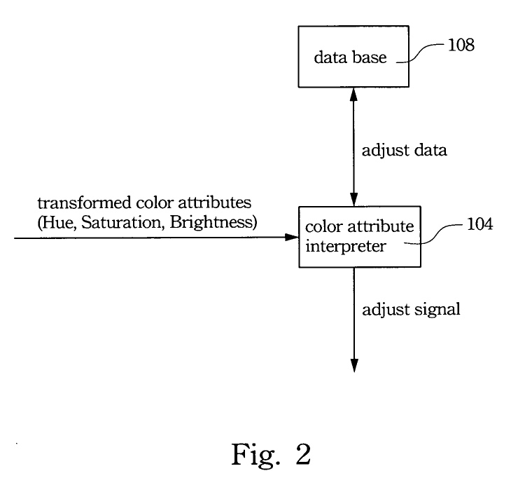

Reference is made to FIG. 2, which is a drawing of the color attribute interpreter according to one preferred embodiment of the invention for illustrating the relationship between the color attribute interpreter and a database. The color image enhancement apparatus further includes a database 108, arranged to store a plurality of adjust data corresponding to different pixel data for the color attribute interpreter 104 to generate the adjust signal according to the corresponding adjust data of the transformed color attributes.

The adjust data corresponding to different pixel data is stored in the database in advance. Preferably, the adjust data directly corresponds to the transformed color attributes of different original pixel data. For example, the database 108 is a lookup table, suitable data bank, equations or other data structure. Moreover, the database 108 may be integrated in the color attribute interpreter 104, not an independent device as shown in the embodiment of the invention.

The color attribute interpreter 104 can avoid excessive and overly complex calculation by the database 108 such that this embodiment can substantially increase the processing speed of the color attribute interpreter 104. However, the color interpreter 104 interprets each of the transformed color attributes in real time and generates the adjust signal according to each of the transformed color attributes if the interpreting rule of the color attribute interpreter 104 is well defined and the processing speed of the color attribute interpreter 104 is sufficient.

Furthermore, the color attribute transformer 102, the color attribute interpreter 104 and the color attribute adjuster 106 may be software applications or hardware circuits in one embodiment of the invention. In addition, the color attribute transformer 102, the color attribute interpreter 104 and the color attribute adjuster 106 may also be other suitable devices as required, and the color attribute transformer 102, the color attribute interpreter 104 and the color attribute adjuster 106 need not all be software applications or all be hardware circuits.

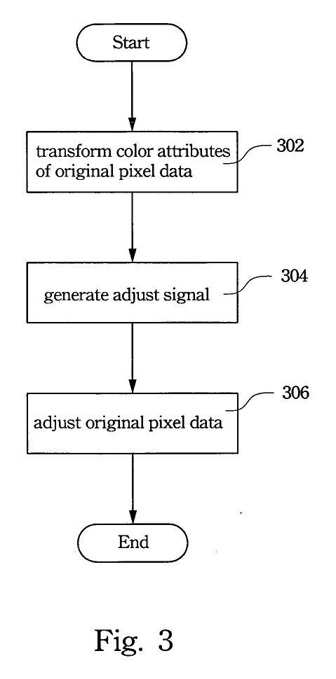

Reference is made to FIG. 3, which is a flow chart according to one preferred embodiment of the invention. A color image enhancement method includes the following steps. Step 302 is transforming color attributes of an original pixel data. The transformed color attributes represent a Hue, a Saturation and a Brightness by HSV color coordinates. Then, step 304 is generating an adjust signal according to the transformed color attributes. Each adjustment of the adjust signal for each of the Hue, the Saturation or the Brightness is determined by all of the Hue, the Saturation and the Brightness of the original pixel data. Finally, the step 306 is adjusting the original pixel data according to the adjust signal to obtain an adjusted pixel data.

The color attributes of the original pixel data are represented by RGB, YUV, YCbCr or YPbPr color coordinates. However, these color coordinates are not suitable for human vision. Thus, the transformed color attributes transformed from the color attributes of the original pixel data are represented by HSV color coordinates, which is suited to human vision.

More specifically, this embodiment of the invention transforms the color attributes of the original pixel data from being represented by rectangular coordinates, for example, RGB, YUV, YCbCr or YPbPr color coordinates, to polar coordinates, for example, HSV color coordinates. That is, the transformed color attributes represented by polar coordinates are beneficial to be adjusted because a Hue, Saturation and Brightness thereof are suitable for a human visual model.

In addition, the color image enhancement method further includes providing a plurality of adjust data corresponding to different original pixel data and generating the adjust signal according to the corresponding adjust data of the transformed color attributes. The generating step can avoid excessive and overly complex calculation by the adjust data such that this embodiment can substantially increase the processing speed of the generating step. However, the generating step interprets each of the transformed color attributes in real time and generates the adjust signal according to each of the transformed color attributes if the interpreting rule is well defined and the processing speed is sufficient.

The foregoing embodiments of the invention first transform color attributes of the pixel data such that they are adaptable for a human visual model represented by a Hue, a Saturation and a Brightness. Moreover, how the Hue, the Saturation or the Brightness adjusted is determined by all of the Hue, the Saturation and the Brightness of the pixel data. Thus, the color behavior of the color image, such as a Saturation or a Brightness, directed to each pixel data of different Hue is enhanced for providing a preferred visual effect to the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color image enhancement apparatus comprising:
a color attribute interpreter, arranged to generate at least one adjust signal according to a Hue, a Saturation and a Brightness of a pixel data, wherein each adjustment of the adjust signal for each of the Hue, the Saturation or the Brightness is determined by all of the Hue, the Saturation and the Brightness of the pixel data; and
a color attribute adjuster connected to the color attribute interpreter, arranged to receive the adjust signal and adjust the pixel data according to the adjust signal.

2. The color image enhancement apparatus as claimed in claim 1, wherein the Hue, the Saturation and the Brightness of the pixel data are represented by HSV color coordinates.

3. The color image enhancement apparatus as claimed in claim 1, further comprising:
a database, arranged to store a plurality of adjust data corresponding to different pixel data for the color attribute interpreter to generate the adjust signal according to the corresponding adjust data of the Hue, the Saturation and the Brightness of the pixel data.

4. The color image enhancement apparatus as claimed in claim 1, further comprising:
a color attribute transformer, connected to the color attribute interpreter and arranged to transform the pixel data before the color attribute interpreter, wherein the Hue, the Saturation and the Brightness of the transformed pixel data are represented by HSV color coordinates.

5. The color image enhancement apparatus as claimed in claim 4, wherein the Hue, the Saturation and the Brightness of the pixel data before being transformed are represented by RGB color coordinates, YUV color coordinates, YCbCr color coordinates or YPbPr color coordinates.

6. A color image enhancement method comprising the steps of:
generating at least one adjust signal according to a Hue, a Saturation and a Brightness of a pixel data, wherein each adjustment of the adjust signal for each of the Hue, the Saturation or the Brightness is determined by all of the Hue, the Saturation and the Brightness of the pixel data; and
adjusting the pixel data according to the adjust signal.

7. The color image enhancement method as claimed in claim 6, wherein the Hue, the Saturation and the Brightness of the pixel data are represented by HSV color coordinates.

8. The color image enhancement method as claimed in claim 6, further comprising:
providing a plurality of adjust data corresponding to different pixel data; and
generating the adjust signal according to the corresponding adjust data of the Hue, the Saturation and the Brightness of the pixel data.

9. A color image enhancement method comprising the steps of:
transforming color attributes of an original pixel data, wherein the transformed color attributes represent a Hue, a Saturation and a Brightness by HSV color coordinates;
generating an adjust signal according to the transformed color attributes, wherein each adjustment of the adjust signal for each of the Hue, the Saturation and the Brightness is determined together by the Hue, the Saturation and the Brightness of the original pixel data; and
adjusting the original pixel data according to the adjust signal to obtain an adjusted pixel data.

10. The color image enhancement method as claimed in claim 9, wherein the color attributes of the original pixel data are represented by RGB color coordinates, YUV color coordinates, YCbCr color coordinates or YPbPr color coordinates.

11. The color image enhancement method as claimed in claim 9, further comprising:
providing a plurality of adjust data corresponding to different original pixel data; and
generating the adjust signal according to the corresponding adjust data of the transformed color attributes.
